(19) United States
(12) Patent Application Publication
(10) Pub. No.: US 2004/0203393 A1
(43) Pub. Date: Oct. 14, 2004

(54) System and method for offsetting channel spectrum to reduce interference between two communication networks

(76) Inventor: Xiang Chen, Gaithersburg, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 10/096,600

(22) Filed: Mar. 13, 2002

(51) Int. Cl. H04B 15/00

(52) U.S. Cl. 455/63.1; 455/454; 455/12.1

(57) ABSTRACT

A system and method for operating two components of a communication system within the same spectrum is provided. A first component is associated with a first set of channels and a second component is associated with a second set of channels. The center frequencies of the first set of channels are offset from the center frequencies of the second set of channels and rolloff filtering is employed in order to minimize interference between channels in the first component and overlapping channels in the second component.

### FIELD OF THE INVENTION

The present invention is related to communications systems. In particular, the present invention is related to a system and method for increasing the total capacity in two communications networks utilizing a common spectrum by offsetting the spectrum of the first network with respect to the second network.

### BACKGROUND OF THE INVENTION

The mobile satellite service (MSS) industry has the potential to provide ubiquitous, low-cost, high-quality voice and data telecommunications services on a truly global basis. The successful operation of an MSS system gives people in rural and underserved areas access to the same advanced communications capabilities that urban users take for granted. Unfortunately, while MSS systems are highly advantageous in rural and low-population areas, technical difficulties make pure satellite systems unsuitable in urban high-population areas.

One problem with modem MSS networks is with coverage in urban areas. Satellite signals typically have difficulty reaching user terminals inside buildings and in “urban canyons.” As a result, terrestrial networks are typically preferred in high-population urban areas. However, terrestrial networks are undesirable in rural and low-population areas due to the cost of building infrastructure to cover large geographic areas and the relatively few number of users in those areas. Hence, a truly ubiquitous solution would combine the benefits of a purely satellite network with the benefits of a terrestrial network in the urban high-population areas.

Another problem with a pure satellite network is that the same large beam, global coverage architecture that makes MSS system so valuable also makes them subject to severe localized capacity limitations. These limitations represent a serious impediment for the MSS industry, as well as a waste of valuable spectrum.

Furthermore, satellite only MSS service requires a different power budget than a hybrid satellite-terrestrial service, and up until now this has made MSS phones large and expensive. Furthermore, the unavailability of the MSS signal in urban and indoor settings makes the demand for MSS phones so low that it is impossible to achieve scale economies anything like those achieved for terrestrial wireless networks.

Several potential solutions have been investigated but have not been found to be completely sufficient. For example, presently existing wireless technology, such as Bluetooth or IEEE 802.11, could allow whole range of consumer devices—standard terrestrial phones, PDAs, or laptop computers—to communicate with a satellite transceiver close by that houses the antennas, amplifiers, and other electronics unique and specific to the satellite link. Such a solution might, in some cases, make MSS handsets more consumer-friendly and affordable. However, Bluetooth represents at best a partial remedy: it cannot, for example, account for coverage problems due to urban canyons and other obstacles. Rather, a more complete remedy is necessary.

Some have attempted to address the chronic problems facing the MSS industry with a dual-band roaming arrangement, under which urban terrestrial mobile subscribers roaming into rural environments could access an MSS network and rural MSS subscribers roaming into cities could access terrestrial mobile services. There are a number of flaws in this approach. Conspicuously, the dual-band roaming approach results in two bands being used to provide what is essentially one service. In urban areas only the terrestrial frequencies are used, the MSS spectrum is wasted. Conversely, in rural areas, only the MSS frequencies are used and terrestrial noble spectrum is wasted. Furthermore, in addition to the spectrum inefficiencies entailed by this approach, it implicitly cuts holes in the MSS operator's authorized service area, thus depriving the operator of any realistic possibility of providing service to the most densely populated areas. The economics of such a model simply do not support continued investment and technological advances in the MSS sector. Moreover, dual-band roaming necessarily results in an MSS operator's inability to ensure service quality with respect to urban operations.

A more elegant solution would be to add an ancillary terrestrial component (ATC) to an existing MSS network in order to provide service in indoor and urban environments. Such an approach would reuse the band of the spectrum allocated to the MSS network operator in a terrestrially based component which serves indoor and urban environments. The ATC approach allows more efficient use of valuable spectrum, as well as allowing a single MSS operator to service customers in both rural and urban environments. An intergrated satellite and terrestrial network operated by a single network operator will allow the kind of integration between network components required to make the most efficient possible use of the valuable 2 GHz spectrum allocated to the operator.

Naturally, operating a satellite component as well as a terrestrial component within the same band of the spectrum presents the potential of causing interference between the two components where user terminals are using overlapping frequencies or channels. Therefore, there is an existing need in the MSS industry for a technique of minimizing the interference between two networks utilizing the same band of the spectrum.

### SUMMARY OF THE INVENTION

The above disadvantages are substantially overcome and other advantages are realized by providing a system for communicating over two networks using the same spectrum. The system comprises a first network adapted to utilize a spectrum of frequencies, with the spectrum being divided into a first plurality of channels. A second network is adapted to utilize the same spectrum of frequencies, with the spectrum being divided into a second plurality of channels, such that the first plurality of channels are offset from the second plurality of channels.

The invention is further embodied in a method of operating two communication networks comprising the steps of associating a spectrum of frequencies to a first network, dividing the spectrum into a first plurality of channels, associating the spectrum of frequencies to a second network, and dividing the spectrum into a second plurality of channels, with the second plurality of channels being offset from the first plurality of channels.

The invention is further embodied in a computer readable medium of instructions adapted to control two communication networks comprising a first set of instructions adapted to control a first network to divide a spectrum of frequencies into a first plurality of channels. The embodiment further comprises a second set of instructions adapted to control the fist network to transmit a first signal on a first one of said first plurality of channels. Furthermore, a third set of instructions is adapted to control a second network to divide the spectrum of frequencies into a second plurality of channels, with the second plurality of channels being off set from the first plurality of channels. Finally, a fourth set of instructions adapted to control the second network to transmit a second signal on a first one of the second plurality of channels.

### BRIEF DESCRIPTION OF THE DRAWINGS

The invention will be more readily understood with reference to the attached figures, in which:

FIG. 1 is a diagram of system components and signal paths in a system according to an embodiment of the present invention;

FIG. 2 is a diagram illustrating channels in respective satellite component and ancillary terrestrial components of a network not employing channel offset;

FIG. 3 is a diagram illustrating the effects of rolloff filtering on a channel;

FIG. 4 is a diagram illustrating channels in respective satellite and ancillary terrestrial components of a network employing channel offsetting in accordance with an embodiment of the present invention; and

FIG. 5 illustrates a system according to an embodiment of the present invention including a user terminal adapted to access both the satellite component and the ancillary terrestrial component of the network.

In the figures, it will be understood that like numerals refer to like features and structures.

### DETAILED DESCRIPTION OF THE INVENTION

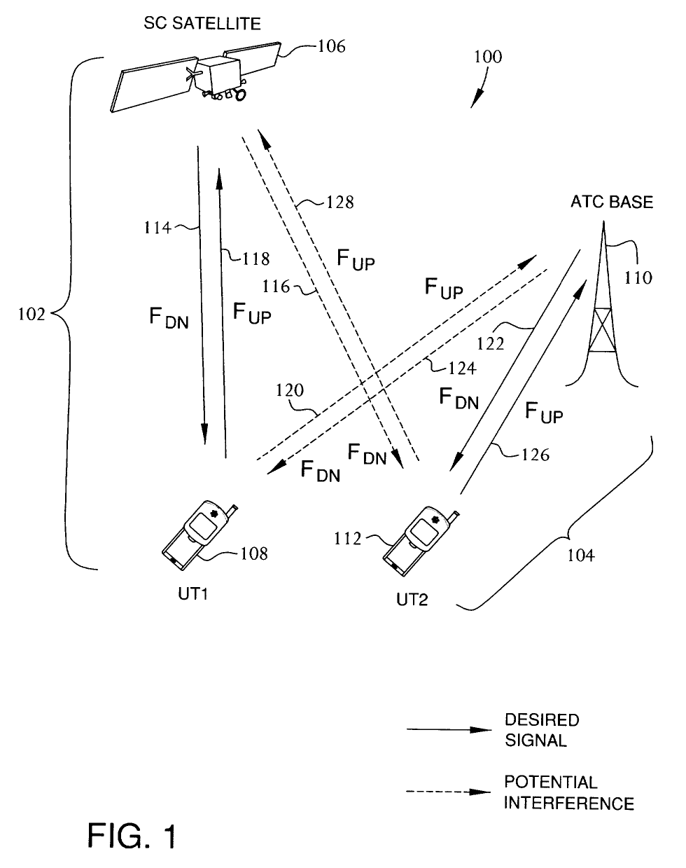

FIG. 1 illustrates a system 100 according to an embodiment of the present invention. The system comprises a satellite component 102 and an ancillary terrestrial component 104. Of course, those of skill in the art will readily appreciate that the present invention could be employed in any two networks using common spectrum, although in the preferred embodiment the system 100 comprises satellite 102 and ancillary terrestrial 104 components.

The satellite component 102 comprises a satellite 106 and at least one user terminal 108. The user terminal 108 preferably communicates via the satellite 106 on two channels. In FIG. 1 the uplink frequency designated as F_{UP} while the downlink frequency is designated as F_{DN}.

The ancillary terrestrial component 104 comprises a terrestrial base station 110 and at least one user terminal 112. The user terminal 112 preferably communicated via the terrestrial base station 110 on two channels. In one embodiment of the invention, the two components share the same frequency for uplink on both networks. This is referred to as forward band sharing mode. As shown in FIG. 1, the uplink frequency is designated as F_{UP} and the downlink frequency is designated as F_{DN}. In this arrangement, the uplink frequency (F_{UP}) is the same for the user terminal 108 accessing the satellite 106 and the user terminal 112 accessing the terrestrial base station 110. Similarly, both user terminals share the downlink frequency (F_{DN}).

Another embodiment which is preferred in practice is referred to as reverse band sharing mode. In this mode, the two networks share the same frequency, but the uplink band of one network is used for the downlink band of the second network. Thus, in the arrangement shown in FIG. 1, user terminal 108 would use F_{UP} as the uplink frequency and F_{DN} as the downlink frequency in the satellite component. However, in the ancillary terrestrial component, user terminal 112 would use F_{DN} as the uplink frequency to ATC base 110, and F_{UP} as the downlink frequency. Forward band sharing mode is described herein for illustrative purposes, but it will be readily appreciated that the principles of the present invention could be applied equally to reverse band sharing mode as well.

Because the satellite 102 and ancillary terrestrial 104 components share frequencies, there is the potential for interference between the two systems. While the satellite 106 transmits to user terminal 108 over F_{DN}, shown at 114, any other user terminals within the satellite's beam also receives signal energy within the same channel. Thus, a user terminal 112 tuned to the same channel on the ancillary terrestrial network receives signals 116 on the same channel as interference. Likewise transmissions from user terminal 108 to satellite 106, shown at 118, are perceived by the terrestrial base station as interference signals 120. Signals from terrestrial base station 110 to user terminal 112, shown at 122, cause interference signals 124 for user terminal 108. Finally, signals intended to be transmitted from user terminal 112 to base station 110, shown at 126, cause interference signals 128 at the satellite 106.

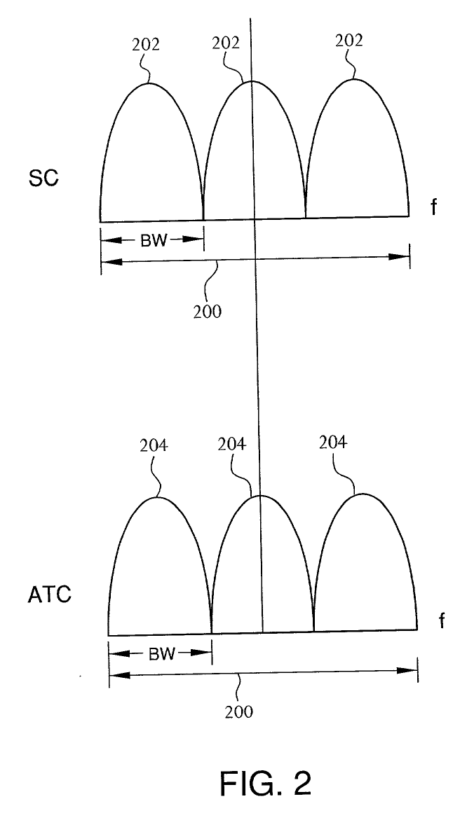

FIG. 2 illustrates the channel alignment of two networks sharing spectrum, but not employing channel offsetting in accordance with an embodiment of the present invention. The satellite component (SC) is allocated a range of frequencies 200 which is divided into a plurality of channels 202. For illustrative purposes, the channels 202 are each shown with an equal bandwidth (BW). Also shown is an ancillary terrestrial component (ATC) which has been allocated the same range of frequencies 200. The ATC is also divided into a plurality of channels 204, which each occupy the same bandwidth (BW). In this illustration, the channels 202 and the channels 204 are aligned such that the center frequency of each channel in the SC is aligned with or substantially aligned with the center frequency of a channel in the ATC. Interference in a system configured as shown in FIG. 2 is mitigated by coordinating the use of channels in the SC and ATC portions to minimize use of the same channel in both components simultaneously. Unfortunately, this method may fail to maximize the use of the spectrum allocated to both components.

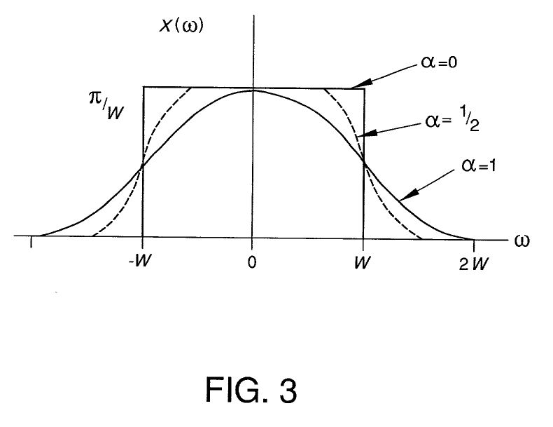

It is well understood by those of skill in the art of telecommunications that perfect bandpass or lowpass filters are not physically realizable. Therefore, a certain amount of crosstalk interference will always occur between adjacent channels in a communication system. A common approach to reduce adjacent channel interference is the raised cosine rolloff filter. This concept is illustrated in FIG. 3. In a raised cosine rolloff filter, a is the rolloff factor. A rolloff factor of α=0 corresponds to the unrealizable perfect lowpass filter, in which the filter response is constant over the entire bandwidth of the channel [−W, +W] and zero everywhere else. In such a perfect system, interference between adjacent channels would be eliminated.

Rolloff factors of α=½ and 1 are also shown in FIG. 3. As the rolloff factor increases, filter response of the system causes the higher frequency components within the channel to be diminished, and also causes some energy in frequencies outside the channel to be retained. Real world systems are typically designed with a rolloff factor equal to α=0.3. The symbol rate (SR) obtainable in a given channel with bandwidth equal to B is given as follows:

SR=B/(1+α)

Thus, in a typical system with rolloff factor α=0.3, and a channel bandwidth B=25 kHz, the obtainable symbol rate is given as follows:

SR=B/(1+α)=25 kHz/1.3=19.2 k sym/sec

Of course as will be appreciated by those of skill in the art, the above symbol rate, rolloff factor and channel configuration are merely illustrative, and it is contemplated that a wide variety of rolloff factors, channel bandwidths and symbol rates are within the scope of the present invention.

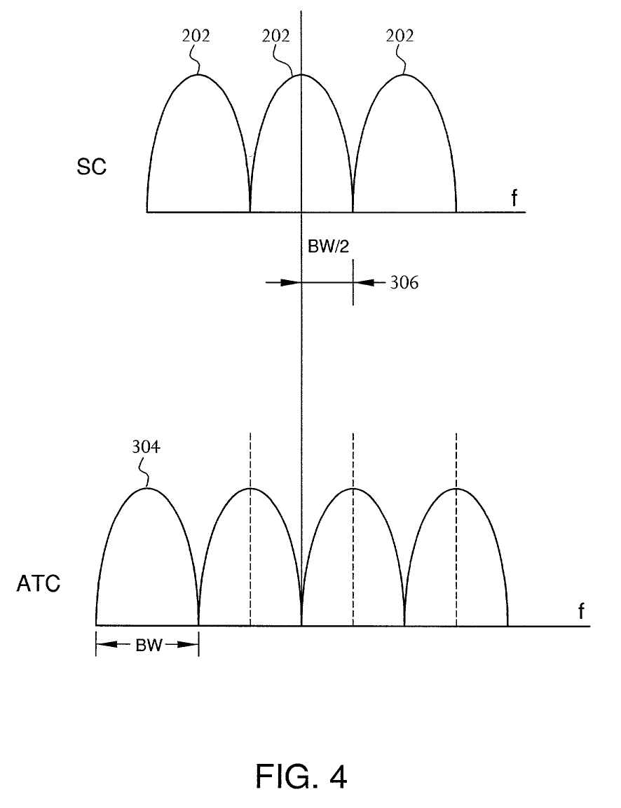

FIG. 4 illustrates a channel alignment according to an embodiment of the present invention. A satellite component (SC) is allocated a spectrum, and that spectrum is divided into a plurality of channels 302 shown with bandwidth BW. An ancillary terrestrial component (ATC) operates within the same spectrum as the satellite component, and also has a plurality of channels 304 each with bandwidth BW. However, the center frequency of the ATC channels 304 are offset 306 from the center frequency of the SC channels 302. The offset is preferably one half the bandwidth of the channels.

Because of the unique arrangement of channels between the satellite and ancillary terrestrial components, interference between channels in the satellite component and channels occupying the same portion of the spectrum in the ancillary terrestrial component is minimized. Due to filtering, such as raised cosine rolloff filtering as discussed above, the energy in each channel is concentrated around the center frequency. Furthermore, very little energy is present near the channel boundaries. Thus, the center frequencies of the satellite component channels (and hence most of the signal energy in the channel) are aligned with the channel boundaries in the ancillary terrestrial component, where there is relatively little signal energy to cause interference. Thus, even if channels in the ATC are in use which overlap channels in the SC, the interference is minimized because the signal energy at the boundaries of the ATC channels is very small relative to the strong signal energy at the SC channel center frequency.

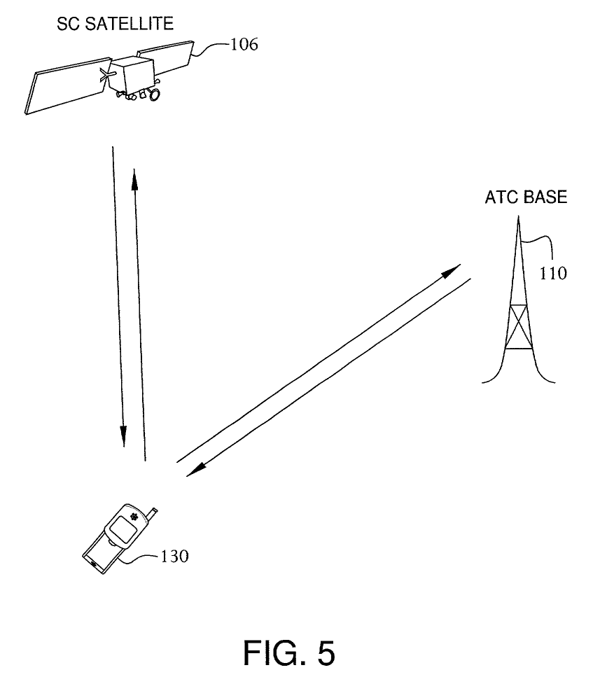

A system 100 according to an embodiment of the present invention is shown in FIG. 5. A user terminal adapted for use in a system according to an embodiment of the present invention is shown at 130. The user terminal 130 is adapted to choose between the satellite component of the communication network, and the ancillary terrestrial component. Advantageously, the user terminal is designed to receive only the single common spectrum allocated to both the satellite component and the ancillary terrestrial component. When operating in a first mode, the user terminal 130 divides the spectrum into a first plurality of channels associated with the satellite 106. When operating in a second mode, the user terminal 130 divides the spectrum into a second plurality of channels associated with the ancillary terrestrial component 110.

At certain times, only the satellite component will be available to the user terminal 130, as in when the user terminal 130 is far from any city (outside the coverage area of the terrestrial component). At these times, the user terminal will operate in the first mode.

At other times, only the ancillary terrestrial component will be available to the user terminal 130, such as when the user terminal 130 is inside a building or urban canyon in a city. At these times, the user terminal will operate in the second mode.

Finally, there will be many situations in which the user terminal 130 will have both the satellite and the ancillary terrestrial components available. In these situations, the user terminal is adapted to select either the first mode or the second more, depending on a number of factors, including power consumption and network traffic conditions. As described above, both the satellite component and ancillary terrestrial component are able to operate in the same spectrum while minimizing interference between channels in the satellite component and overlapping channels in the ancillary terrestrial component.

While the invention herein disclosed has been described by means of specific embodiments and applications thereof, numerous modifications and variations could be made thereto by those skilled in the art without departing from the scope of the invention set forth in the claims.

What is claimed is:

1. A system for communicating over two networks using the same spectrum comprising:
a first network adapted to utilize a spectrum of frequencies, said spectrum divided into a first plurality of channels; and
a second network adapted to utilize said spectrum of frequencies, said spectrum divided into a second plurality of channels, wherein said first plurality of channels are offset from said second plurality of channels.

2. The system of claim 1, wherein said first network further comprises a first transmitter comprising a channel filter.

3. The system of claim 2, wherein said channel filter comprises a raised cosine rolloff filter.

4. The system of claim 1, wherein said first plurality of channels are of equal bandwidth.

5. The system of claim 4, wherein said second plurality of channels are of equal bandwidth.

6. The system of claim 5, wherein said offset is equal to one half of the channel bandwidth.

7. The system of claim 1, wherein said first network includes a satellite network.

8. The system of claim 1, wherein said second network includes a terrestrial network.

9. A method of operating two communications networks comprising the steps of:
associating a spectrum of frequencies to a first network,
dividing said spectrum into a first plurality of channels,
associating said spectrum of frequencies to a second network, and
dividing said spectrum into a second plurality of channels, said second plurality of channels being offset from said first plurality of channels.

10. The method of claim 9, further comprising the step of transmitting a signal on a first one of said first plurality of channels.

11. The method of claim 10, further comprising the step of filtering said signal prior to said transmitting step.

12. The method of claim 11, wherein said filtering step utilizes raised cosine rolloff filtering.

13. The method of claim 9, wherein said first plurality of channels are of equal bandwidth.

14. The method of claim 13, wherein said second plurality of channels are of equal bandwidth.

15. The method of claim 14, wherein said offset is equal to one half of said channel bandwidth.

16. The method of claim 9, wherein said first network includes a satellite network.

17. The method of claim 9, wherein said second network includes a terrestrial network.

18. A computer readable medium of instructions adapted to control two communication networks comprising:
a first set of instructions adapted to control a first network to divide a spectrum of frequencies into a first plurality of channels,
a second set of instructions adapted to control said first network to transmit a first signal on a first one of said first plurality of channels,
a third set of instructions adapted to control a second network to divide said spectrum of frequencies into a second plurality of channels, said second plurality of channels being offset from said first plurality of channels, and
a fourth set of instructions adapted to control said second network to transmit a second signal on a first one of said second plurality of channels.

19. The computer readable medium of instructions as in claim 18, further comprising a fifth set of instructions adapted to control said first network to filter said first signal prior to transmitting said first signal.

20. The computer readable medium of instructions as in claim 19, wherein said filter is a raised cosine rolloff filter.

21. The computer readable medium of instructions as in claim 18, wherein said first plurality of channels are of equal bandwidth.

22. The computer readable medium of instructions as in claim 21, wherein said second plurality of channels are of equal bandwidth.

23. The computer readable medium of instructions as in claim 22, wherein said offset is equal to one half of said channel bandwidth.

24. The computer readable medium of instructions as in claim 18, wherein said first network includes a satellite network.

25. The computer readable medium of instructions as in claim 18, wherein said second network includes a terrestrial network.
